(19) United States
(12) Patent Application Publication
(10) Pub. No.: US 2026/0206764 A1
(43) Pub. Date: Jul. 23, 2026

(54) AN HERBICIDAL COMBINATION, COMPOSITION AND METHOD OF CONTROLLING WEEDS USING THE SAME

(71) Applicants: UPL Mauritius Limited, Port Louis (MU); UPL Europe Supply Chain GMBH, Risch (CH)

(72) Inventors: Giuvan Lenz, Pereiras-SP (BR); Jessica Ferreira Lourenco Leal, Pereiras-SP (BR); Ganesh Rao, Mumbai (IN)

(21) Appl. No.: 19/142,876

(22) PCT Filed: Jan. 9, 2024
(86) PCT No.: PCT/EP2024/050372

§ 371 Date: Jun. 24, 2025

(30) Foreign Application Priority Data
Jan. 9, 2023 (IN) 202311001721

(51) Int. Cl. A01N 57/20; A01N 43/40; A01N 43/60; A01P 13/02

(52) U.S. Cl. CPC A01N 57/20; A01N 43/40; A01N 43/60; A01P 13/02

(57) ABSTRACT

The present invention relates to a herbicidal combination comprising L-glufosinate, salts, esters, or combinations thereof, and at least one additional herbicide. The present invention also relates to a herbicidal composition comprising L-glufosinate, salts, esters, or combinations thereof, and at least one additional herbicide, and methods of controlling weeds using the same thereof.

### FIELD OF THE INVENTION

The present invention relates to a herbicidal combination comprising L-glufosinate, salts, esters, or combinations thereof, and at least one additional herbicide. The present invention also relates to a herbicidal composition comprising L-glufosinate, salts, esters, or combinations thereof, and at least one additional herbicide, and methods of controlling weeds using the same thereof.

### BACKGROUND OF THE INVENTION

Herbicides are pesticides useful for killing or controlling unwanted plants. Generally, there are two kinds of herbicides-selective and non-selective herbicides. Selective herbicides kill certain target weeds while leaving the desired crop relatively unharmed, while non-selective herbicides kill both the weeds and the crops. Profitable crop production depends on effective weed control. The weeds can reduce crop yields by competing for water, sunlight, and nutrients. In today's crop production systems, starting off with a good burn-down program is necessary as it helps to achieve maximum initial crop growth and reduce weed interference during early stages of the crop cycle. Since the weed-crop competition is critical during the early stages of crop cycle, the weed interference at an early stage has a direct impact on the yield of the crop.

An effective weed control can be achieved by usage of herbicides appropriately. The activity of herbicides can be enhanced in various ways to achieve the maximum benefit. One of the ways is to use combinations of herbicides. However, identifying appropriate combinations, their agrochemical application rates, and ratio of the combinations is essential to achieve efficacious control. Also, the selection of a particular formulation type is more cumbersome for an agrochemical combination. Thus, herbicides play an important role for weed control in maximizing crop yield.

Also, applying combinations of herbicidal compounds may enhance the herbicidal effectiveness.

Many agrochemicals have chiral structures. For example, about 30% of currently registered pesticidal active ingredients contain one or more chiral structures. Some chiral herbicides are sold as purified, optically active isomers, but for economic reasons, many others are still used as racemates. Different enantiomers of chiral herbicides can have different enantioselective activities on target weeds and different toxic effects on non-target organisms because of their enantioselective interactions with enzymes and biological receptors in organisms but the herbicidal selectivity of a specific isomer is not predictable. Although the enantiomers of chiral substances have the same physicochemical properties, their biochemical activities can be different because biochemical processes usually show high stereo or enantioselectivity. The “active” enantiomer of a chiral chemical may have the desired effect on a target species, whereas the other enantiomer may not. It is advisable to use only the biologically active enantiomers, thereby reducing the total amount of chemical pollutants released into the environment.

Glufosinate (also known as phosphinothricin; DL-homoalanin-4-yl(methyl)phosphinic acid) is a racemic phosphinico amino acid. Its ammonium salt (glufosinate-ammonium) is widely used as a non-selective herbicide and is an active ingredient of many commercial herbicide formulations. Glufosinate is a contact herbicide and is taken up by the plant primarily through the leaves. There is no uptake from the soil through the roots, presumably because of the rapid degradation of glufosinate by soil micro-organisms. There is also limited translocation of glufosinate within the plant. Glufosinate has a wide spectrum of activity encompassing monocotyledonous and dicotyledonous species. However, due to its limited systemic action, there is no enduring effect on perennial weeds. Hoechst et al., in 1991, reported examples of weed species which are either not combated, or only weakly combated by glufosinate such as Viola arvensis, Bromus spp., Lolium spp., Agropyron repens and Urtica urens. Moreover, weeds emerging after herbicide application are not affected. Furthermore, L-Glufosinate has herbicidal activity, which is about four times that of glyphosate, about twice that of paraquat, and more than about twice that of racemic glufosinate (DL-glufosinate).

Therefore, with limitations on individual efficacies of the existing herbicides in terms of activity and target, there is an underlying need for an effective herbicidal combination which overcomes the previously known shortcomings of the solo active ingredients. There remains a great need for improved broadleaf and grassy weed control herbicidal compositions and a method of controlling such noxious vegetation in pre and post emergence without adversely affecting desirable plants and which reduces the amount of chemical herbicidal agent necessary to obtain the acceptable weed control.

### Objectives of the Invention

It is a primary objective of the present invention to provide a herbicidal combination for efficient weed control, weed suppression and eradication.

It is another objective of the present invention to provide a herbicidal combination comprising highly effective herbicidal actives for selective and non-selective weed control.

It is another objective of the present invention to provide a herbicidal combination comprising highly effective herbicidal actives for an efficient burn-down program.

It is another objective of the present invention to provide a synergistic herbicidal combination to control, suppress or prevent a wide spectrum of weeds and target plants, both dicotyledonous and monocotyledonous, broad-leaved, and grassy weeds.

It is yet another objective of the present invention to provide a herbicidal combination which is safe to use, effective and can be applied pre-emergence, post-emergence or at the time of sowing.

It is also an objective of the present invention to provide a herbicidal composition for control of a wide spectrum of weeds and target plants, both dicotyledonous and monocotyledonous, broad-leaved and grassy weeds.

It is another objective of the present invention to provide use of a herbicidal combination or a composition comprising such a combination for controlling or killing weeds.

It is yet another objective of the present invention to provide a method of controlling or killing weeds with a herbicidal combination or a composition comprising such a combination.

Additionally, it is another objective of the invention to provide a method of controlling resistant varieties of weeds with a suitable herbicidal combination or a composition comprising such a combination.

### SUMMARY OF THE INVENTION

In an aspect, the present invention hereby provides a herbicidal combination comprising L-glufosinate, salts, esters, or combinations thereof, and at least one additional herbicide selected from the group comprising phenoxypropionic herbicides.

In another aspect, the present invention provides a synergistic herbicidal combination comprising L-glufosinate, salts, esters, or combinations thereof, and at least one additional herbicide selected from the group comprising phenoxypropionic herbicides.

Another aspect of the present invention provides a herbicidal composition comprising L-glufosinate, salts, esters, or combinations thereof, and at least one additional herbicide selected from the group comprising phenoxypropionic herbicides.

An aspect of the present invention provides a herbicidal composition comprising L-glufosinate, salts, esters, or combinations thereof, at least one additional herbicide selected from the group comprising phenoxypropionic herbicides; and at least one agrochemically acceptable excipient.

An aspect of the present invention also provides a herbicidal combination comprising L-glufosinate, salts, esters, or combinations thereof, at least one additional herbicide selected from the group comprising phenoxypropionic herbicides, and a second additional herbicide. The said combination may also have synergistic properties. An embodiment of the present invention also provides a herbicidal composition comprising said combination.

An aspect of the present invention also provides a process of preparing a herbicidal composition comprising L-glufosinate, salts, esters, or combinations thereof, and at least one additional herbicide selected from the group comprising phenoxypropionic herbicides.

Another aspect of the present invention provides a method of controlling weeds, the method comprising applying to a plant or a locus thereof, a herbicidal combination comprising L-glufosinate, salts, esters, or combinations thereof, and at least one additional herbicide selected from the group comprising phenoxypropionic herbicides. In an embodiment, the combination further comprises a second additional herbicide. The said combinations are synergistic in their effect towards the weeds.

An aspect also provides a method of controlling weeds, the method comprising applying to a plant or a locus thereof, a herbicidal composition comprising L-glufosinate, salts, esters, or combinations thereof, and at least one additional herbicide selected from the group comprising phenoxypropionic herbicides. In an embodiment, the composition further comprises a second additional herbicide.

Yet another aspect provides use of a herbicidal combination comprising L-glufosinate, salts, esters, or combinations thereof, and at least one additional herbicide selected from the group comprising phenoxypropionic herbicides, for effective control of weeds. The combination was found to possess synergistic effects on the plant or the locus thereof.

An aspect of the present invention also provides a kit-of-parts comprising a component of L-glufosinate, salts, esters, or combinations thereof and another component of at least one additional herbicide selected from the group comprising phenoxypropionic herbicide. The said components may be mixed at the time of application as per the given set of instructions.

### DETAILED DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about” and is meant to encompass variations of ±10%, ±5%, ±1%, ±0.5%, or even ±0.1% of the specified value as well as the specified value.

Thus, before describing the present invention in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

It must be noted that, as used in this specification, the singular forms “a”, “an” and “the” include plural referents unless the content clearly dictates otherwise. The terms “preferred” and “preferably” refer to embodiments of the invention that may afford certain benefits, under certain circumstances.

As used herein, the terms “comprising”, “including”, “having”, “containing”, “involving” and the like are to be understood to be open-ended, i.e., to mean including but not limited to.

The term “herbicide” as used herein means an active ingredient that kills, controls or otherwise adversely modifies the growth of plants. As used herein, a herbicidally effective or vegetation controlling amount is an amount of active ingredient that causes a “herbicidal effect”, i.e., an adversely modifying effect and includes deviations from natural development, killing, regulation, desiccation, retardation, and methods known to a person skilled in the art.

The terms “plants” and “vegetation” include, but are not limited to, germinant seeds, emerging seedlings, plants emerging from vegetative propagules, and established vegetation. The term “weed” refers to unwanted vegetation and includes any plant which grows where it is not wanted, including pesticide resistant plants. In the broadest sense, the term “weed” refers to plants which grow in locations in which they are not desired. In other words, a “weed” is a plant in which in the context of a crop is undesirable due to competition for water, nutrients, sunlight, soil, etc. The term may also refer to crop plants which are undesirable at a location. As used herein, the terms “undesirable vegetation”, “undesirable species”, “undesirable plants”, “harmful plants”, “undesirable weeds”, “harmful weeds” or “weed” are synonyms.

Typically, the combinations/compositions of the present invention are applied to the targeted weed or to their locus or to the crop/plant. The term “locus” as used herein shall denote the vicinity of a desired crop in which weed control, typically selective weed control is desired. The locus includes the vicinity of desired crop plants wherein the weed infestation has either emerged or is yet to emerge. The term crop shall include a multitude of desired crop plants or an individual crop plant growing at a locus. The said locus could be a weed, an area adjacent to the weed, soil adapted to support growth of the weed, a root of the weed and/or foliage of the weed.

In any aspect or embodiment described hereinbelow, the phrase comprising may be replaced by the phrases “consisting of” or “consisting essentially of” or “consisting substantially of”. In these aspects or embodiment, the combination or composition described includes or comprises or consists of or consists essentially of or consists substantially of the specific components recited therein, to the exclusion of other fungicides or insecticide or plant growth promoting agents, adjuvants, or excipients not specifically recited therein.

The terms “g a.i./L” as used herein denotes the concentration of the respective active ingredient in “grams” present “per litre” of the composition. The terms “g a.i./L”, “g a.i./L” and “g/L” may be used interchangeably.

The terms “g a.i./ha” as used herein denotes the concentration of the respective active ingredient in “grams” applied “per hectare” of the crop field. The terms “g ai/ha”, “g a.i./ha” and “g/ha” may be used interchangeably.

An effective weed control can be achieved by usage of herbicides appropriately. The activity of herbicides can be enhanced in various ways to achieve the maximum benefit. One of the ways is to use herbicides with different herbicidal combinations. However, identifying appropriate combinations, their agrochemical application rates, and ratio of the combinations is essential to achieve efficacious control, which is not straight forward.

Accordingly, the present invention provides a method for partially or completely controlling harmful weeds with a combination of two or more herbicides.

According to the inventors of the present invention, they found unexpected advantages on combining L-glufosinate with at least one additional herbicide selected from the group comprising phenoxypropionic herbicides in pursuit of an efficient and synergistic solution for weed control.

In an embodiment, the herbicidal combination comprises: L-glufosinate, salts, esters, or combinations thereof; and at least one additional herbicide selected from the group comprising phenoxypropionic herbicides.

In an embodiment, the L-glufosinate is a free acid.

In an embodiment, the salt comprises an inorganic salt of L-glufosinate.

In an embodiment, the inorganic salt of L-glufosinate is selected from the group comprising L-glufosinate ammonium, L-glufosinate sodium, L-glufosinate potassium, or combinations thereof.

The inorganic salts of L-glufosinate can be selected from the group comprising monosodium salt, disodium salt, monopotassium salt, dipotassium salt, calcium salt, ammonium salt, —NH3(CH3)+ salt, —NH2(CH3)2+ salt, —NH(CH3)3+ salt, —NH(CH3)2(C2H4OH)+ salt, —NH2(CH3)(C2H4OH)+ salt, or combinations thereof. The choice of the specific salt form is not particularly limiting. Exemplary salts of L-glufosinate are L-glufosinate-ammonium (also called glufosinate-P-ammonium), which is ammonium (2S)-2-amino-4-(methylphosphinato)butyric acid (CAS Reg. No. 73777-50-1); L-glufosinate-sodium (also called glufosinate-P-sodium), which is sodium (2S)-2-amino-4-(methylphosphinato)butyric acid (CAS Reg. No. 70033-13-5) and L-glufosinate-potassium (also called glufosinate-P-potassium), which is potassium (2S)-2-amino4-(methylphosphinato)butyric acid.

In an embodiment, the L-glufosinate salt is L-glufosinate ammonium.

In an embodiment, the L-glufosinate salt is L-glufosinate sodium.

In an embodiment, the L-glufosinate salt is L-glufosinate potassium.

As used herein, the term “L-glufosinate” or “L-isomer of glufosinate” are synonymous and interchangeable and also includes salts and ester forms of L-glufosinate. The L-isomer of glufosinate is a structural analogue of glutamate and, therefore, is a competitive inhibitor of the enzyme glutamine synthetase (GS) of bacteria and plants. The L-isomer, also called ass L-enantiomer, of glufosinate acts by inhibition of glutamine synthetase thereby causing accumulation of toxic levels of ammonium ion and indirectly stopping photosynthesis. It is also known as phosphinothricin or (S)-2-amino-4-(hydroxy(methyl)phosphonoyl) butanoic acid. The term can generically refer to any form of L-glufosinate such as solvates, hydrates, esters, anhydrous form, polymorph forms, pseudo polymorph forms, amorphous form or mixture thereof, and sodium, potassium or ammonium salts. The term may also refer to an isomeric (racemic) mixture of L-glufosinate, D-glufosinate and salts thereof, wherein the content of L-glufosinate in the mixture is about 70% or greater, preferably about 80% or greater and more preferably about 90% or greater. Typically, the ratio of L-glufosinate: D-glufosinate can be in the range from about 95:5 to about 99.9:0.1.

In an embodiment, the phenoxypropionic herbicide comprises a arylphenoxypropionic herbicide.

In an embodiment, the phenoxypropionic herbicide is selected from the group comprising chlorazifop, chlorazifop-propargyl, clodinafop, clodinafop propargyl, clofop, clofop-isobutyl, cyhalofop, cyhalofop-butyl diclofop, diclofop-methyl, difenopenten, fenoxaprop, fenoxaprop-P, fenthiaprop, fluazifop, fluazifop-butyl, fluazifop-P, fluazifop-P-butyl, haloxyfop, haloxyfop-sodium, haloxyfop-methyl, haloxyfop-etotyl, haloxyfop-P, haloxyfop-P-methyl, isoxapyrifop, kuicaoxi, metamifop, propaquizafop, quizalofop, quizalofop-ethyl, quizalofop-P, quizalofop-P-ethyl, quizalofop-P-tefuryl, trifop, trifopsime, or combinations thereof.

In a preferred embodiment, the phenoxypropionic herbicide is chlorazifop or chlorazifop-propargyl.

In a preferred embodiment, the phenoxypropionic herbicide is clodinafop or clodinafop propargyl.

In a preferred embodiment, the phenoxypropionic herbicide is clofop or clofop-isobutyl.

In a preferred embodiment, the phenoxypropionic herbicide s cyhalofop or cyhalofop-butyl.

In a preferred embodiment, the phenoxypropionic herbicide is diclofop or diclofop-methyl.

In a preferred embodiment, the phenoxypropionic herbicide is difenopenten.

In a preferred embodiment, the phenoxypropionic herbicide is fenoxaprop.

In a preferred embodiment, the phenoxypropionic herbicide is fenoxaprop-P.

In a preferred embodiment, the phenoxypropionic herbicide is fenthiaprop.

In a preferred embodiment, the phenoxypropionic herbicide is fluazifop or fluazifop-butyl.

In a preferred embodiment, the phenoxypropionic herbicide is fluazifop-P or fluazifop-P-butyl.

In a preferred embodiment, the phenoxypropionic herbicide is haloxyfop, haloxyfop-sodium, haloxyfop-methyl, or haloxyfop-etotyl.

In a preferred embodiment, the phenoxypropionic herbicide is haloxyfop-P or haloxyfop-P-methyl.

In a preferred embodiment, the phenoxypropionic herbicide is isoxapyrifop.

In a preferred embodiment, the phenoxypropionic herbicide is kuicaoxi.

In a preferred embodiment, the phenoxypropionic herbicide is metamifop.

In a preferred embodiment, the phenoxypropionic herbicide is propaquizafop.

In a preferred embodiment, the phenoxypropionic herbicide is quizalofop or quizalofop-ethyl.

In a preferred embodiment, the phenoxypropionic herbicide is quizalofop-P.

In a preferred embodiment, the phenoxypropionic herbicide is quizalofop-P-ethyl.

In a preferred embodiment, the phenoxypropionic herbicide is quizalofop-P-tefuryl.

In a preferred embodiment, the phenoxypropionic herbicide is trifop.

In a preferred embodiment, the phenoxypropionic herbicide is trifopsime.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is chlorazifop or chlorazifop-propargyl.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is clodinafop or clodinafop propargyl.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is clofop or clofop-isobutyl.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is cyhalofop or cyhalofop-butyl.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide diclofop or diclofop-methyl.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is difenopenten.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is fenoxaprop.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is fenoxaprop-P.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is fenthiaprop.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is fluazifop or fluazifop-butyl.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is fluazifop-P or fluazifop-P-butyl.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is haloxyfop, haloxyfop-sodium, haloxyfop-methyl, or haloxyfop-etotyl.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is haloxyfop-P or haloxyfop-P-methyl.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is isoxapyrifop.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is kuicaoxi.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is metamifop.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is propaquizafop.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is quizalofop or quizalofop-ethyl.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is quizalofop-P.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is quizalofop-P-ethyl.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is quizalofop-P-tefuryl.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is trifop.

In an embodiment, there is provided a herbicidal combination comprising L-glufosinate, salts, esters, or combinations thereof, and at least one additional herbicide selected from the group comprising phenoxypropionic herbicides, wherein the phenoxypropionic herbicide is trifopsime.

According to an embodiment, L-glufosinate, salts, esters, or combinations thereof is a herbicide of the organophosphate herbicide class.

According to an embodiment, L-glufosinate, salts, esters, or combinations thereof is a herbicide of the glutamine synthetase inhibitor herbicide class.

According to an embodiment, the phenoxypropionic herbicides are acetyl CoA carboxylase (ACCase) inhibitor herbicides.

According to an embodiment, the said combination of L-glufosinate, and the herbicide of the phenoxypropionic herbicide class is a synergistic combination. In various embodiments, the herbicidal activity of a combination according to the present invention exceeds the total of the activities of the individual active compounds. For the two active compounds in a combination or when applied together to form a combination, the activity will be greater than the sum of the single active compound alone. Thus, in various embodiments, herbicidal combinations include combinations which are synergistic for control of one or more weeds.

The use of the combinations/compositions according to the present invention provides for excellent herbicidal effectiveness against a broad spectrum of economically important mono- and dicotyledonous annual weeds and perennial weeds.

According to another embodiment, the present invention provides a synergistic herbicidal combination of L-glufosinate, salts, esters, or combinations thereof, and an herbicide of the phenoxypropionic herbicide class.

According to an embodiment L-glufosinate, salts, esters, or combinations thereof and the herbicide of the phenoxypropionic herbicide class are combined in a weight ratio of 1000:1 to 1:1000. Specifically, the two actives are combined in a weight ratio of 750:1 to 1:750. According to an embodiment, L-glufosinate, salts, esters, or combinations thereof and the herbicide of the phenoxypropionic herbicide class are combined in a weight ratio of 500:1 to 1:500. According to an embodiment, L-glufosinate, salts, esters, or combinations thereof and the herbicide of the phenoxypropionic herbicide class are combined in a weight ratio of 250:1 to 1:250. According to an embodiment, L-glufosinate, salts, esters, or combinations thereof and the herbicide of the phenoxypropionic herbicide class are combined in a weight ratio of 100:1 to 1:100. According to an embodiment, L-glufosinate, salts, esters, or combinations thereof and the herbicide of the phenoxypropionic herbicide class are combined in a weight ratio of 75:1 to 1:75. According to an embodiment, L-glufosinate, salts, esters, or combinations thereof and the herbicide of the phenoxypropionic herbicide class are combined in a weight ratio of 50:1 to 1:50.

According to an embodiment, a weight ratio of L-glufosinate, salts, esters, or combinations thereof to at least one additional herbicide selected from the group comprising phenoxypropionic herbicides is in a range from about 25:1 to about 1:25.

According to an embodiment, a weight ratio of L-glufosinate, salts, esters, or combinations thereof to at least one additional herbicide selected from the group comprising phenoxypropionic herbicides is in a range from about 10:1 to about 1:10.

An embodiment of the present invention provides an herbicidal combination comprising L-glufosinate, salts, esters, or combinations thereof and at least two herbicides of the phenoxypropionic herbicide class. In an embodiment, said combination demonstrates efficacy greater than additive effect of individual efficacies of the constituent herbicides.

In an embodiment, L-glufosinate and at least two herbicides of the phenoxypropionic herbicide class are combined in a ratio of 1:1000:1000 to 1000:1:1.

In an embodiment, L-glufosinate and at least two herbicides of the phenoxypropionic herbicide class are combined in a ratio of 1:100:100 to 100:1:1.

In an embodiment, L-glufosinate and at least two herbicides of the phenoxypropionic herbicide class are combined in a ratio of 1:25:25 to 25:1:1.

An embodiment of the present invention provides an herbicidal composition comprising L-glufosinate, salts, esters, or combinations thereof and an herbicide of the phenoxypropionic herbicide class.

An embodiment of the present invention provides an herbicidal composition comprising a synergistic herbicidal combination of L-glufosinate, salts, esters, or combinations thereof and an herbicide of the phenoxypropionic herbicide class.

In an embodiment, the total amount of L-glufosinate, salts, esters, or combinations thereof in the composition may typically be in the range of about 0.1% to about 99% by weight. The total amount of the herbicide of the phenoxypropionic herbicide class in the composition may be in the range of about 0.1% to about 99% by weight.

An embodiment of the present invention provides an herbicidal composition comprising L-glufosinate, salts, esters, or combinations thereof and at least two herbicides of the phenoxypropionic herbicide class.

An embodiment of the present invention provides an herbicidal composition comprising a synergistic herbicidal combination of L-glufosinate, salts, esters, or combinations thereof and at least two herbicides of the phenoxypropionic herbicide class.

In an embodiment, the combinations or compositions of the present invention further comprise a second additional herbicide. Thus, an embodiment of the present invention presents an herbicidal combination comprising L-glufosinate, salts, esters, or combinations thereof, an herbicide of the phenoxypropionic herbicide class, and a second additional herbicide. An embodiment of the present invention also provides a composition comprising said combination. In another embodiment, said composition further comprises at least one agrochemically acceptable excipient.

In an embodiment, the total amount of the second additional herbicide in the composition may be in the range of about 0.1% to about 99% by weight.

In an embodiment, the constituent herbicides L-glufosinate, salts, esters, or combinations thereof and the herbicide of the phenoxypropionic herbicide class in the composition of the present invention may be admixed in a ratio of about 1000:1 to about 1:1000.

In an embodiment, the constituent herbicides L-glufosinate, salts, esters, or combinations thereof, the herbicide of the phenoxypropionic herbicide class, and the second additional herbicide in the composition of the present invention may be admixed in a ratio of about 1000:1:1 to about 1:1000:1000. In an embodiment, the constituent herbicides L-glufosinate, salts, esters, or combinations thereof, the herbicide of the phenoxypropionic herbicide class, and the second additional herbicide in the composition of the present invention may be admixed in a ratio of about 100:1:1 to about 1:100:100. In an embodiment, the constituent herbicides L-glufosinate, salts, esters, or combinations thereof, the herbicide of the phenoxypropionic herbicide class, and the second additional herbicide in the composition of the present invention may be admixed in a ratio of about 25:1:1 to about 1:25:25.

According to an embodiment, L-glufosinate is present as its ammonium salt in the present compositions.

In an embodiment, the combinations or compositions of the present invention may be substantially free of any other herbicide.

In an embodiment, the amount of L-glufosinate, salts, esters, or combinations thereof in the combinations or compositions of the present invention may range from about 1 to 1000 g a.i./L. In an embodiment, the amount of L-glufosinate, salts, esters, or combinations thereof in the combinations or compositions of the present invention may range from about 10 to 1000 g a.i./L. In an embodiment, the amount of L-glufosinate, salts, esters, or combinations thereof in the combinations or compositions of the present invention may range from about 50 to 1000 g a.i./L. In an embodiment, the amount of L-glufosinate, salts, esters, or combinations thereof in the combinations or compositions of the present invention may range from about 100 to 1000 g a.i./L. In an embodiment, the amount of L-glufosinate, salts, esters, or combinations thereof in the combinations or compositions of the present invention may range from about 100 to 500 g a.i./L. In an embodiment, the amount of L-glufosinate, salts, esters, or combinations thereof in the combinations or compositions of the present invention may range from about 100 to 400 g a.i./L. In an embodiment, the amount of L-glufosinate, salts, esters, or combinations thereof in the combinations or compositions of the present invention may range from about 180 to 380 g a.i./L. In an embodiment, the amount of L-glufosinate, salts, esters, or combinations thereof in the combinations or compositions of the present invention may range from about 250 to 300 g a.i./L.

In one preferred embodiment, in combinations or compositions of the present disclosure, L-glufosinate, salts, esters, or combinations thereof is present in an amount of about 280 g a.i./L. In one preferred embodiment, in combinations or compositions of the present disclosure, L-glufosinate, salts, esters, or combinations thereof is present in an amount of about 250 g a.i./L. In one preferred embodiment, in combinations or compositions of the present disclosure, L-glufosinate, salts, esters, or combinations thereof is present in an amount of about 150 g a.i./L.

In an embodiment, the amount of the herbicide of the phenoxypropionic herbicide class in the combinations or compositions of the present invention may range from about 1 to 1000 g a.i./L. In an embodiment, the amount of the herbicide of the phenoxypropionic herbicide class in the combinations or compositions of the present invention may range from about 10 to 1000 g a.i./L. In an embodiment, the amount of the herbicide of the phenoxypropionic herbicide class in the combinations or compositions of the present invention may range from about 50 to 1000 g a.i./L. In an embodiment, the amount of the herbicide of the phenoxypropionic herbicide class in the combinations or compositions of the present invention may range from about 100 to 1000 g a.i./L. In an embodiment, the amount of the herbicide of the phenoxypropionic herbicide class in the combinations or compositions of the present invention may range from about 100-400 g a.i./L. In an embodiment, the amount of the herbicide of the phenoxypropionic herbicide class in the combinations or compositions of the present invention may range from about 150 to 350 g a.i./L. In an embodiment, the amount of the herbicide of the phenoxypropionic herbicide class in the combinations or compositions of the present invention may range from about 200-300 g a.i./L.

In an embodiment, the combination of the present invention comprises L-glufosinate ammonium at 280 g a.i./L and haloxyfop at 125 g a.i./L.

In an embodiment, the combination of the present invention comprises L-glufosinate ammonium at 280 g a.i./L and quizalofop-ethyl at 50 g a.i./L.

In an embodiment, the combination of the present invention comprises L-glufosinate ammonium at 280 g a.i./L and quizalofop-P-tefuryl at 120 g a.i./L.

In an embodiment, the combination comprises:
L-glufosinate, salts, esters, or combinations thereof in a range from about 100 g a.i./L to about 400 g a.i./L; and
at least one additional herbicide selected from the group comprising phenoxypropionic herbicides in a range from about 100 g a.i./L to about 400 g a.i./L.

In an embodiment, there is provided a composition comprising L-glufosinate, an herbicide of the phenoxypropionic herbicide class, and at least one agrochemically suitable excipient. In an embodiment, there is provided a composition comprising L-glufosinate, an herbicide of the phenoxypropionic herbicide class, a second additional herbicide, and at least one agrochemically suitable excipient.

In an embodiment, the composition of the present invention comprises L-glufosinate ammonium at 280 g a.i./L; haloxyfop at 125 g a.i./L; and at least one agrochemically acceptable excipient.

In an embodiment, the combination of the present invention comprises L-glufosinate ammonium at 280 g a.i./L, quizalofop-ethyl at 50 g a.i./L, and at least one agrochemically acceptable excipient.

In an embodiment, the combination of the present invention comprises L-glufosinate ammonium at 280 g a.i./L, quizalofop-P-tefuryl at 120 g a.i./L, and at least one agrochemically acceptable excipient.

The agrochemically suitable excipient may be any one or a combination of adjuvants, co-solvents, surfactants, colorants, dispersants, emulsifiers, thickeners, antifreeze agents, biocides, anti-foam agents, stabilizers, wetting agents or a mixture thereof which may be optionally added to the compositions of the present invention.

The surfactants may be selected from non-ionic, anionic or cationic surfactants. Examples of non-ionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C₈-C₂₂ alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono- and diesters of ethylene glycol and mixtures thereof.

Examples of anionic surfactants include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C₁₂-C₁₅ alkanols or polyalkoxylated C₁₂-C₁₅ alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates.

Cationic surfactants include alkanol amides of C₈-C₁₈ fatty acids and C₈-C₁₈ fatty amine polyalkoxylates, C₁₀-C₁₈ alkyldimethylbenzylammonium chlorides, coconut alkyldimethylaminoacetic acids, and phosphate esters of C₈-C₁₈ fatty amine polyalkoxylates.

Emulsifiers which can be advantageously employed herein can be readily determined by those skilled in the art and include various non-ionic, anionic, cationic and amphoteric emulsifiers, or a blend of two or more emulsifiers. Examples of non-ionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether.

In an embodiment, colorants may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc.

Another embodiment involves addition of a thickener or binder which may be selected from but not limited to molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols.

In another embodiment, antifreeze agent(s) added to the composition may be alcohols selected from the group comprising of but not limited to ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol.

According to an embodiment, biocides may be selected from benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl.

According to an embodiment, antifoam agent may be selected from Polydimethoxysiloxane, polydimethylsiloxane, Alkyl poly acrylates, Castor Oil, Fatty Acids, Fatty Acids Esters, Fatty Acids Sulfate, Fatty Alcohol, Fatty Alcohol Esters, Fatty Alcohol Sulfate, Foot Olive Oil, Mono & Di Glyceride, Paraffin Oil, Paraffin Wax, Poly Propylene Glycol, Silicones Oil, Vegetable Fats, Vegetable Fats Sulfate, Vegetable Oil, Vegetable Oil Sulfate, Vegetable Wax, Vegetable Wax Sulfate, agents based on silicon or magnesium stearate.

The additives to be used for the formulation include, for example, a solid carrier such as kaolinite, sericite, diatomaceous earth, slaked lime, calcium carbonate, talc, white carbon, kaoline, bentonite, clay, sodium carbonate, sodium bicarbonate, mirabilite, zeolite or starch; a solvent such as water, toluene, xylene, solvent naphtha, dioxane, dimethylsulfoxide, N,N-dimethylformamide, dimethylacetamide, N-methyl-2-pyrrolidone or an alcohol; an anionic surfactant such as a salt of fatty acid, a benzoate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenylether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonic acid condensed with formaldehyde or a salt of alkylnaphthalene sulfonic acid condensed with formaldehyde; a nonionic surfactant such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil, corn oil, rice bran oil, peanut oil, cottonseed oil, soybean oil, rapeseed oil, linseed oil, tung oil or liquid paraffins. These additives may suitably be selected for use alone or in combination as a mixture of two or more of them, so long as the object of the present invention is met. Further, additives other than the above-mentioned may be suitably selected for use among those known in this field. For example, various additives commonly used, such as a filler, a thickener, an anti-settling agent, an anti-freezing agent, a dispersion stabilizer, a safener, an anti-mold agent, a bubble agent, a disintegrator and a binder, may be used.

The agrochemical formulation may also comprise one or more antioxidants. Preferably, the agrochemical formulation comprises an antioxidant. Antioxidants are, for example, amino acids (e.g. glycine, histidine, tyrosine, tryptophan) and derivatives thereof, imidazole and imidazole derivatives (e.g. urocanic acid), peptides, such as, for example, D,L-carnosine, D-carnosine, L-carnosine and derivatives thereof (e.g. anserine), carotenoids, carotenes (e.g. α-carotene, β-carotene, lycopene) and derivatives thereof, lipoic acid and derivatives thereof (e.g. dihydrolipoic acid), aurothioglucose, propylthiouracil and further thio compounds (e.g. thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g. buthionine sulfoximines, homocysteine sulfoximine, buthionine sulfones, penta-, hexa-, heptathionine sulfoximine) in very low tolerated doses (e.g. pmol/kg to pmol/kg), also metal chelating agents (e.g. α-hydroxy fatty acids, EDTA, EGTA, phytic acid, lactoferrin), α-hydroxy acids (e.g. citric acid, lactic acid, malic acid), humic acids, bile acid, bile extracts, gallic esters (e.g. propyl, octyl and dodecyl gallate), flavonoids, catechins, bilirubin, biliverdin and derivatives thereof, unsaturated fatty acids and derivatives thereof (e.g. γ-linolenic acid, linoleic acid, arachidonic acid, oleic acid), folic acid and derivatives thereof, hydroquinone and derivatives thereof (e.g. arbutin), ubiquinone and ubiquinol, and derivatives thereof, vitamin C and derivatives thereof (e.g. ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g. tocopheryl acetate, linoleate, oleate and succinate, tocophereth-5, tocophereth-10, tocophereth-12, tocophereth-18, tocophereth-50, tocophersolan), vitamin A and derivatives (e.g. vitamin A palmitate), the coniferyl benzoate of benzoin resin, rutin, rutinic acid and derivatives thereof, disodium rutinyl disulfate, cinnamic acid and derivatives thereof (e.g. ferulic acid, ethyl ferulate, caffeeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g. selenomethionine), stilbenes and stilbene derivatives (e.g. stilbene oxide, trans-stilbene oxide). According to the invention, suitable derivatives (salts, esters, sugars, nucleotides, nucleosides, peptides and lipids) and mixtures of these specified active ingredients or plant extracts (e.g. teatree oil, rosemary extract and rosemarinic acid) which comprise these antioxidants can be used. In general, mixtures of the aforementioned antioxidants are possible.

According to an embodiment, examples of suitable solvents are water, aromatic solvents (for example, xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones (NMP, NEP, NOP), acetates (glycol diacetate), glycols, fatty acid dimethylamides, fatty acids and fatty acid esters, isophorone and dimethylsulfoxide. In principle, solvent mixtures may also be used.

According to an embodiment, suitable surfactants are alkali metal, alkaline earth metal and ammonium salts of lignosulfonic acid, naphthalenesulfonates, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

According to an embodiment, examples of suitable carriers are mineral earths such as silica gels, silicates, talc, kaolin, attaclay, attapulgite, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders, polyvinylpyrrolidone and other solid carriers.).

Suitable preservatives are for example 1,2-benzisothiazolin-3-one and/or 2-Methyl-2H-isothiazol-3-one or sodium benzoate or benzoic acid.

The herbicidal combinations and compositions of the present disclosure can be in any conventional agriculturally useful form, for example, in the form of a ready-to-use formulation, or in the form of a tank mix.

In an embodiment, the herbicidal actives may be formulated as a premix product or a ready-to-use product.

In an embodiment, the herbicidal actives may be tank-mixed at the time of application.

In an embodiment, the method comprises applying the present combinations or compositions simultaneously, that is jointly or separately, or in succession. The combination is applied jointly, or separately, or sequentially, or simultaneously to a plant or locus thereof to control from about 30% to about 100% of the weeds. In an embodiment, the weeds are selected from the group comprising Eleusine indica, Brachiaria decumbens, Spermacoce latifolia, Glycine max, or combinations thereof.

In another embodiment, the constituents of the combination of the present invention may be tank mixed and applied or sprayed at the locus of the infection or may be alternatively mixed with surfactants and/or any other agrochemically suitable excipients and then applied.

In yet another embodiment, the constituents of the combination of the present invention may be applied in such quick succession in any order to form the desired mix at the locus of application.

In an embodiment, the constituents of the composition of the present invention may be used for foliar application, ground or applications to plant propagation materials. The combination or tank-mix of L-glufosinate, salts, esters, or combinations thereof and an herbicide of the phenoxypropionic herbicide class also includes a combination or a mixture of a composition comprising L-glufosinate, salts, esters, or combinations thereof, and a composition comprising the herbicide of the phenoxypropionic herbicide class. Each individual composition may comprise one or more agrochemically suitable excipient/ingredients. The resulting combination or tank-mix of the composition comprising L-glufosinate, salts, esters, or combinations thereof and the composition comprising an herbicide of the phenoxypropionic herbicide class provides a synergistic effect in controlling the weeds. Additionally, the tank-mix combination may further comprise a composition comprising a second additional herbicide.

In an embodiment, the composition may be in any agriculturally suitable form for storage and application to the ground. The compositions of the present invention may typically be produced by mixing the actives in the composition with an inert carrier, and adding surfactants and other adjuvants and carriers as needed and formulated into solid, or liquid formulations, including but not limited to wettable powders, granules, dusts, Soluble (liquid) concentrates, suspension concentrates, oil in water emulsion, water in oil emulsion, emulsifiable concentrates, capsule suspensions, ZC formulations, oil dispersions or other known formulation types. The composition may also be used for treatment of a plant propagation material such as seeds etc.

According to an embodiment, the combinations and/or compositions of the present invention may be further combined or applied with a second additional herbicide.

According to an embodiment, the present invention provides a composition comprising L-glufosinate, salts, esters, or combinations thereof, an herbicide of the phenoxypropionic herbicide class and a second additional herbicide.

Non-limiting examples of the second additional herbicide comprise 2,4-D, anisiflupurin, acetochlor, aclonifen, amicarbazone, halauxifen, halauxifen-methyl, florpyrauxifen, amidosulfuron, aminocyclopyrachlor, aminopyralid, aminotriazole, ammonium thiocyanate, anilofos, asulam, azimsulfnron, atrazine, beflubutamid, benazolin, benfuresate, bensulfuron-methyl, bentazon-sodium, benzofenap, bifenox, bixlozone, benquitrione, bipyrazone, bispyribacsodium, bromobutide, bromacil, bromoxynil, butachlor, butafenacil, butralin, butroxydim, carbetamide, cafenstrole, carfentrazone, carfentrazone-ethyl, chlormequat, clopyralid, chlorsulfuron, chlortoluron, cinidon-ethyl, imazethapyr, clodinafop-propargyl, clomeprop, clomazone, cloransulam-methyl, cyanazine, cyclopyrimorate, cyclosulfamuron, cycloxydim, cyhalofop-butyl, cypyrafluone, daimuron, dicamba, dichlobenil, dichlorprop-P, diclofop-methyl, diclosulam, diflufenican, diflufenzopyr, dimefuron, dimethachlor, diquat, dioxopyritrione, diuron, 5-ethyl dipropylcarbamothioate (EPTC), esprocarb, ethoxysulfuron, etobenzanid, fenoxaprop, fenoxaprop-ethyl, fenoxapropethyl+isoxadifen-ethyl, fenoxaprop-P-ethyl, fenoxasulfone, fenquinotrione, fentrazamide, fenpyrazone, flazasulfuron, florasulam, fluazifop, fluazifop-P-butyl, flucarbazone, flucarbazone-sodium, flucetosulfuron (LGC-42153), flufenacet, flumetsulam, flumioxazin, flupyrsulfuron, flurochloridone, fluroxypyr, fluroxypyr-meptyl, flurtamone, glufosinate, glufosinate-ammonium, glyphosate, halosulfuron-methyl, haloxyfop-methyl, haloxyfop-R-methyl, hexazinone, imazamethabenz, imazamox, imazapic, imazapyr, imazaquin, imazosulfuron, indanofan, indaziflam, iodosulfuron, iodosulfuron-ethyl-sodium, iofensulfuron, ioxynil, ipfencarbazone, isoproturon, isoxaben, isoxaflutole, lactofen, linuron, MCPA, MCPB, mecoprop-P, mefenacet, mesosulfuron, mesosulfuron-ethyl sodium, mesotrione, metamifop, metazochlor, metazosulfuron, metosulam, metribuzin, metsulfuron, metsulfuronmethyl, molinate, MSMA, napropamide, napropamide-M, orfurazon, orthosulfamuron, oryzalin, oxadiargyl, oxadiazon, oxazichlomefone, oxyfluorfen, paraquat, pendimethalin, penoxsulam, pentoxazone, pethoxamid, picloram, picolinafen, pinoxaden, pretilachlor, primisulfuron, profluazol, profoxydim, propanil, propaquizafop, propyrisulfuron, propoxycarbazone, propyzamide, prosulfocarb, prosulfuron, pyraclonil, pyraflufen-ethyl, pyrasulfotole, pyrazosulfuron-ethyl, pyrazolynate, pyribenzoxim (LGC-40863), pyributicarb, pyridate, pyriftalid, pyrimisulfan, pyroxsulam, pyroxasulfone, quinclorac, quinmerac, quizalofop-ethyl-D, quizalofop-P-ethyl, quizalofop-P-tefuryl, rimsulfuron, rimisoxafen, sethoxydim, simazine, sulcotrione, sulfentrazone, sulfometuron, sulfosate, sulfosulfuron, tebuthiuron, tefuryltrione, tepraloxidim, terbacil, terbuthylazine, terbutryn, tetflupyrolimet, thenylchlor, thiazopyr, thifensulfuron, thifensulfuron-methyl, thiobencarb, topramezone, tralkoxydim, triafamone, triasulfuron, tribenuron, tribenuron-methyl, triafamone, triclopyr, tripyrasulfone, SL-1201, cyclopyranil, dimesulfazet, epyrifenacil, tembotrione, thiencarbazone methyl, flucetosulfuron, pyrasulfotole, saflufenacil, pyraclonil, fenquinotrione, tiafenacil, cinmethylin, lancotrione-sodium, trifludimoxazin, cyclopyrimorate, methiozolin, aminocyclopyrachlor, bicyclopyrone, triafamone, tolpyralate. trifluralin, and agriculturally acceptable salts, choline salts, esters and mixtures thereof.

In another aspect, present compositions may further comprise at least one safener. In an embodiment, the safener can be selected from the group comprising isoxadifen-ethyl, cloquintocet-mexyl, mefenpyr-diethyl, naphthalic anhydride, oxabetrinil, benzenesulfonamide, N-(aminocarbonyl)-2-chlorobenzene sulfonamide (2-CBSU), daimuron, dichloroacetamide, dicyclonon, fenchlorazole-ethyl, fenclorim, fluxofenim, Dichloroacetamide safeners (e.g., AD-67, benoxacor, dichlormid, and furilazole), naphthopyranone, naphthalic anhydride (NA), oxime, phenylpyrimidine, phenylurea, phenyl pyrazoles compounds, naphthalic anhydride, cyometrinil, flurazole, dimepiperate, methoxyphenone, cloquintocet-mexyl, 1-dichloroacetylhexahydro-3,3,8α-trimethylpyrrolo[1,2-α]pyrimidin-6-(2H-one), dichloromethyl-1,3-dioxolane, quinolinyloxyacetate compounds, or agriculturally acceptable salts, esters, or mixtures thereof.

In accordance with another embodiment of the invention, there is provided a process for preparing a composition comprising L-glufosinate, salts, esters, or combinations thereof, and an herbicide of the phenoxypropionic herbicide class. The said process further involves addition of an agrochemically suitable excipient to the herbicidal actives. Optionally, it includes addition of a second additional herbicide to the mixture. The resulting composition is storage stable with convenient shelf-life.

According to another embodiment, there is provided a use of a combination comprising L-glufosinate, salts, esters, or combinations thereof and an herbicide of the phenoxypropionic herbicide class to control, eradicate or prevent weed growth. In an embodiment, the combination further comprises a second additional herbicide.

According to another embodiment, there is provided a use of a composition comprising L-glufosinate, salts, esters, or combinations thereof and an herbicide of the phenoxypropionic herbicide class to control, eradicate or prevent weed growth. In an embodiment, the composition further comprises a second additional herbicide.

The combinations and compositions of the present invention can be used in agricultural lands such as fields, paddy fields, lawns and orchards or in non-agricultural lands. The present invention may be used to control weeds in agricultural lands for cultivating the crops without any phytotoxicity to the crops. Examples of the crops on which the combinations and compositions of the present invention may be used include but are not limited to corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In a preferred embodiment, the combinations and/or compositions of the present invention are used to control weeds in crops selected from the group of drybeans, sunflower, sorghum, rice, canola, cereals, peanuts, pulses, and sugarcane.

In a preferred embodiment, the combinations and/or compositions of the present invention are used to control weeds in pasture, plantations, trees, vines, and nuts.

According to an embodiment, there is provided a method of controlling weeds at a locus comprising applying to the said locus, a combination comprising L-glufosinate, salts, esters, or combinations thereof, and at least one additional herbicide selected from the group comprising phenoxypropionic herbicides thereof. In an embodiment, said combination is synergistic.

According to an embodiment, there is provided a method of controlling weeds at a locus comprising applying to the said locus, a composition comprising L-glufosinate, salts, esters, or combinations thereof and an herbicide of the phenoxypropionic herbicide class.

According to an embodiment, there is provided a method of controlling weeds at a locus comprising applying to the said locus, a combination or a composition comprising L-glufosinate, salts, esters, or combinations thereof, an herbicide of the phenoxypropionic herbicide class, and a second additional herbicide.

The combinations and compositions of the present invention are used to control weeds in various agricultural crops. Non-limiting examples of weeds controlled by the compositions of the present invention include:
Urticaceae weeds: Urtica urens
Polygonaceae weeds: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicus, Rumex crispus, Rumex obtusifolius, Rumex acetosa; Portulacaceae weeds: Portulaca oleracea; Caryophyllaceae weeds: Stellaria media, Cerastium holosteoides, Cerastium glomeratum, Spergula arvensis, Silene gallica.
Molluginaceae weeds: Mollugo verticillata; Chenopodiaceae weeds: Chenopodium album, Chenopodium ambrosioides, Kochia scoparia, Salsola kali, Atriplex spp.; Amaranthaceae weeds: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera philoxeroides, Alternanthera sessilis, Alternanthera tenella; Papaveraceae weeds: Papaver rhoeas, Argemone Mexicana;
Brassicaceae weeds: Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspi arvense, Myagrum rugosum, Lepidium virginicum, Coronopus didymus; Dinebra weeds: Dinebra americana, Dinebra aquatic, Dinebra aristidoides, Dinebra bromoides, Dinebra calycina, Dinebra caudata, Dinebra chinensis, Dinebra chloride, Dinebra chondrosioides, Dinebra coerulescens, Dinebra cristata, Dinebra curtipendula, Dinebra decipiens, Dinebra divaricate, Dinebra divaricatissima, Dinebra dura, Dinebra guineensis, Dinebra hirsute, Dinebra hirta, Dinebra juncifolia, Dinebra ligulata, Dinebra lima, Dinebra melicoides, Dinebra nealleyi, Dinebra neesii, Dinebra panicea, Dinebra panicoides, Dinebra pubescens, Dinebra repens, Dinebra scabra, Dinebra secunda, Dinebra simoniana, Dinebra southwoodii, Dinebra squarrosa, Dinebra srilankensis, Dinebra tuaensis, Dinebra verticillate, Dinebra retroflexa. Dinebra haareri, Dinebra marquisensis, Dinebra perrieri, Dinebra polycarpha, Dinebra somalensis, Capparaceae weeds: Cleome affinis; Fabaceae weeds: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Vicia angustifolia, Indigofera hirsuta, Indigofera truxillensis, Vigna sinensis; Oxalidaceae weeds: Oxalis corniculata, Oxalis strica, Oxalis oxyptera; Geraniaceae weeds: Geranium carolinense, Erodium cicutarium; Euphorbiaceae weeds: Euphorbia helioscopia, Euphorbia maculate, Euphorbia humistrata, Euphorbia esula, Euphorbia heterophylla, Euphorbia brasiliensis, Acalypha australis, Croton glandulosus, Croton lobatus, Phyllanthus corcovadensis, Ricinus communis; Malvaceae weeds: Corchorus, Abutilon theophrasti, Sida rhombiforia, Sida cordifolia, Sida spinosa, Sida glaziovii, Sida santaremnensis, Hibiscus trionum, Anoda cristata, Malvastrum coromandelianum.
Sterculiaceae weeds: Waltheria indica; Violaceae weeds: Viola arvensis, Viola tricolor; Cucurbitaceae weeds: Sicyos angulatus, Echinocystis lobata, Momordica charantia; Lythraceae weeds: Lythrum salicaria; Apiaceae weeds: Hydrocotyle sibthorpioides; Sapindaceae weeds: Cardiospermum halicacabum; Primulaceae weeds: Anagallis arvensis; Asclepiadaceae weeds: Asclepias syriaca, Ampelamus albidus; Rubiaceae weeds: Galium aparine, Galium spurium var. echinospermon, Spermacoce latifolia, Richardia brasiliensis, Borreria alata, Borreria verticilata; Convolvulaceae weeds: Ipomoea alba, Ipomoea nil, Ipomoea hederacea, Ipomoea purpurea, Ipomoea hederacea var. integriuscula, Ipomoea lacunosa, Ipomoea triloba, Ipomoea acuminata, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoides, Jacquemontia tamnifolia; Boraginaceae weeds: Myosotis arvensis; Lamiaceae weeds: Lamium purpureum, Lamium amplexicaule, Leonotis nepetaefolia, Hyptis suaveolens, Hyptis lophanta, Leonurus sibiricus, Stachys arvensis; Solanaceae weeds: Datura stramonium, Solanum nigrum, Solanum americanum, Solanum ptycanthum, Solanum sarrachoides, Solanum rostratum, Solanum aculeatissimum, Solanum sisymbriifolium, Solanum carolinense, Physalis angulata, Physalis subglabrata, Nicandra physaloides; Scrophulariaceae weeds: Veronica hederaefolia, Veronica persica, Veronica arvensis; Plantaginaceae weeds: Plantago asiatica; Asteraceae weeds: Xanthium pensylvanicum, Xanthium occidentale, Helianthus annuus, Matricaria chamomilla, Matricaria perforata, Chrysanthemum segetum, Matricaria matricarioides, Artemisia princeps, Artemisia vulgaris, Artemisia verlotorum, Solidago altissima, Taraxacum officinale, Galinsoga ciliata, Galinsoga parviflora, Senecio vulgaris, Senecio brasiliensis, Senecio grisebachii, Conyza bonariensis, Conyza canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, Soliva sessilis; Liliaceae weeds: Allium canadense, Allium vineale; Commelinaceae weeds: Cyanotis axillaris, Commelina communis, Commelina benghalensis, Commelina erecta; Poaceae weeds: Dinebra retroflexa, Cynodon dactylon, Echinochloa colonum, Echinochloa crusgalli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium species, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spicaventi, Panicum dichotomiflorum, Panicum texanum, Panicum maximum, Brachiaria reptains Brachiaria platyphylla, Brachiaria ruziziensis, Brachiaria plantaginea, Brachiaria decumbens, Brachiaria brizantha, Brachiaria humidicola, Brachiaria mutica, Cenchrus echinatus, Cenchrus pauciflorus, Eriochloa villosa, Pennisetum setosum, Chloris gayana, Chloris barbata, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, Rottboellia cochinchinensis; Cyperaceae weeds: Cyperus microiria, Cyperus iria, Cyperus odoratus, Cyperus rotundus, Cyperus esculentus, Kyllinga gracillima, Equisetaceae weeds: Equisetum arvense, Equisetum palustre, Trianthema weeds, weedy Glycine max and the like.

According to an embodiment, the weeds targeted by the combinations and compositions of the present invention are grassy weeds and broad-leaved weeds.

It was surprisingly found that the combinations of the present invention were effective and showed synergistic control over resistant varieties of weeds.

In an embodiment, the combinations or the compositions according to the present disclosure may be used for burndown application or fallow application.

In an embodiment, the weed removal is not restricted to crop land or agricultural land only. The weeds are targeted in non-agricultural areas such as, but not limited to, forestries, railways, infrastructure, amenities, companies, factories, roads and runways, sidewalks, highways, dividers, medians, pipelines, public utility lines, pumping stations, transformer stations, substations, around airports, electric utilities, commercial buildings, manufacturing plants, storage yards, rail yards, hangars, fence lines, parking lots, parkways, sedges, post-harvest crop lands, beneath greenhouse benches and around golf courses.

According to an embodiment, there is provided a method of application of a combination or a composition comprising L-glufosinate, salts, esters, or combinations thereof, and an herbicide of the phenoxypropionic herbicide class for control, eradication or prevention of weed growth.

The combination of the present invention maybe applied simultaneously as a tank mix or a premix formulation or may be applied sequentially. The application may be made to the soil before emergence of the plants, either pre-planting or post-planting. The application may be made to the soil after emergence of the plants. The application may be made as a foliar spray at different timings during crop development, with either one or more applications early or late post-emergence. Herbicidal compositions according to the invention can also be incorporated into the soil before, during or after sowing seeds of a crop. These combinations as described above may be applied to the locus of the weeds, in an herbicidally effective amount.

In an embodiment, L-glufosinate, salts, esters, or combinations thereof is applied to a target locus at a rate of about 1-1000 g a.i./ha. In an embodiment, L-glufosinate, salts, esters, or combinations thereof is applied to a target locus at a rate of about 1-500 g a.i./ha. In an embodiment, L-glufosinate, salts, esters, or combinations thereof is applied to a target locus at a rate of about 100-500 g a.i./ha. In an embodiment, L-glufosinate, salts, esters, or combinations thereof is applied to a target locus at a rate of about 100-300 g a.i./ha.

In an embodiment, the herbicide of the phenoxypropionic herbicide class is applied to a target locus at a rate of about 1-1000 g a.i./ha. In an embodiment, the herbicide of the phenoxypropionic herbicide class is applied to a target locus at a rate of about 1-500 g a.i./ha. In an embodiment, the herbicide of the phenoxypropionic herbicide class is applied to a target locus at a rate of about 10-150 g a.i./ha. In an embodiment, the herbicide of the phenoxypropionic herbicide class is applied to a target locus at a rate of about 1-150 g a.i./ha. In an embodiment, the herbicide of the phenoxypropionic herbicide class is applied to a target locus at a rate of about 10-100 g a.i./ha. In an embodiment, the herbicide of the phenoxypropionic herbicide class is applied to a target locus at a rate of about 25-75 g a.i./ha.

In an embodiment, the combination comprises:
L-glufosinate, salts, esters, or combinations thereof applied at an application rate from about 100 g a.i./ha to about 500 g a.i./ha; and
at least one additional herbicide selected from the group comprising phenoxypropionic herbicides applied at an application rate from about 10 g a.i./ha to about 500 g a.i./ha.

When applied to the target locus, L-glufosinate, salts, esters, or combinations thereof is applied at a rate of 1-1000 g a.i./ha, in association with 1-1000 g a.i./ha of an herbicide of the phenoxypropionic herbicide class.

In an embodiment of the combination of the present invention, L-glufosinate, salts, esters, or combinations thereof is applied at a rate of 150 g a.i./ha, in association with 50 g a.i./ha of haloxyfop.

In an embodiment of the composition of the present invention, L-glufosinate, salts, esters, or combinations thereof is applied at a rate of 150 g a.i./ha, in association with 50 g a.i./ha of haloxyfop, with at least one agrochemically acceptable excipient.

In an embodiment, the present invention provides the use of L-glufosinate, salts, esters, or combinations thereof applied at a rate of 150 g a.i./ha, in association with 50 g a.i./ha of haloxyfop to control weeds at a locus.

In an embodiment of the combination of the present invention, L-glufosinate, salts, esters, or combinations thereof is applied at a rate of 150 g a.i./ha, in association with 25 g a.i./ha of quizalofop-ethyl.

In an embodiment of the composition of the present invention, L-glufosinate, salts, esters, or combinations thereof is applied at a rate of 150 g a.i./ha, in association with 25 g a.i./ha of quizalofop-ethyl, with at least one agrochemically acceptable excipient.

In an embodiment, the present invention provides the use of L-glufosinate, salts, esters, or combinations thereof applied at a rate of 150 g a.i./ha, in association with 25 g a.i./ha of quizalofop-ethyl to control weeds at a locus.

In an embodiment of the combination of the present invention, L-glufosinate, salts, esters, or combinations thereof is applied at a rate of 150 g a.i./ha, in association with 25 g a.i./ha of quizalofop-P-tefuryl.

In an embodiment of the composition of the present invention, L-glufosinate, salts, esters, or combinations thereof is applied at a rate of 150 g a.i./ha, in association with 25 g a.i./ha of quizalofop-P-tefuryl, with at least one agrochemically acceptable excipient.

In an embodiment the present invention provides use of a herbicidal combination for controlling weeds, the combination comprising:
L-glufosinate, salts, esters, or combinations thereof; and
at least one additional herbicide selected from the group comprising phenoxypropionic herbicides thereof.

In an embodiment, the present invention provides the use of L-glufosinate, salts, esters, or combinations thereof applied at a rate of 150 g a.i./ha, in association with 25 g a.i./ha of quizalofop-P-tefuryl to control weeds at a locus.

In an embodiment, the present invention provides the use of L-glufosinate, salts, esters, or combinations thereof applied at a rate of 150 g a.i./ha, in association with 50 g a.i./ha of haloxyfop to control at least one weed that is Brachiaria decumbens.

In an embodiment, the present invention provides the use of L-glufosinate, salts, esters, or combinations thereof applied at a rate of 150 g a.i./ha, in association with 50 g a.i./ha of haloxyfop to control at least one weed that is Brachiaria decumbens, wherein the combination provides at least about 65% control of the weed at or within 7 days after its application.

In an embodiment, the present invention provides the use of L-glufosinate, salts, esters, or combinations thereof applied at a rate of 150 g a.i./ha, in association with 50 g a.i./ha of haloxyfop to control at least one weed that is Brachiaria decumbens, wherein the combination provides at least about 95% control of the weed at or within 14 days after its application.

In an embodiment, the present invention provides the use of L-glufosinate, salts, esters, or combinations thereof applied at a rate of 150 g a.i./ha, in association with 50 g a.i./ha of haloxyfop to control at least one weed that is Brachiaria decumbens, wherein the combination provides at least about 65% control of the weed at or within 7 days after its application, and at least about 95% control of the weed at or within 14 days after its application.

In an embodiment, the present invention provides the use of L-glufosinate, salts, esters, or combinations thereof applied at a rate of 150 g a.i./ha, in association with 25 g a.i./ha of quizalofop-ethyl to control at least one weed that is Brachiaria decumbens.

In an embodiment, the present invention provides the use of L-glufosinate, salts, esters, or combinations thereof applied at a rate of 150 g a.i./ha, in association with 25 g a.i./ha of quizalofop-ethyl to control at least one weed that is Brachiaria decumbens, wherein the combination provides at least about 80% control of the weed at or within 28 days after its application.

In an embodiment, the present invention provides the use of L-glufosinate, salts, esters, or combinations thereof applied at a rate of 150 g a.i./ha, in association with 25 g a.i./ha of quizalofop-ethyl to control at least one weed that is Brachiaria decumbens, wherein the combination provides at least about 80% control of the weed at or within 35 days after its application.

In an embodiment, the present invention provides the use of L-glufosinate, salts, esters, or combinations thereof applied at a rate of 150 g a.i./ha, in association with 25 g a.i./ha of quizalofop-ethyl to control at least one weed that is Brachiaria decumbens, wherein the combination provides at least about 80% control of the weed at or within 28 days after its application, and at least about 80% control of the weed at or within 35 days after its application.

In an embodiment, the present invention provides the use of L-glufosinate, salts, esters, or combinations thereof applied at a rate of 150 g a.i./ha, in association with 25 g a.i./ha of quizalofop-p-tefuryl to control at least one weed that is Brachiaria decumbens.

In an embodiment, the present invention provides the use of L-glufosinate, salts, esters, or combinations thereof applied at a rate of 150 g a.i./ha, in association with 25 g a.i./ha of quizalofop-p-tefuryl to control at least one weed that is Brachiaria decumbens, wherein the combination provides at least about 82% control of the weed at or within 14 days after its application.

In an embodiment, the present invention provides the use of L-glufosinate, salts, esters, or combinations thereof applied at a rate of 150 g a.i./ha, in association with 25 g a.i./ha of quizalofop-p-tefuryl to control at least one weed that is Brachiaria decumbens, wherein the combination provides at least about 80% control of the weed at or within 21 days after its application.

In an embodiment, the present invention provides the use of L-glufosinate, salts, esters, or combinations thereof applied at a rate of 150 g a.i./ha, in association with 25 g a.i./ha of quizalofop-p-tefuryl to control at least one weed that is Brachiaria decumbens, wherein the combination provides at least about 80% control of the weed at or within 28 days after its application.

In an embodiment, the present invention provides the use of L-glufosinate, salts, esters, or combinations thereof applied at a rate of 150 g a.i./ha, in association with 25 g a.i./ha of quizalofop-p-tefuryl to control at least one weed that is Brachiaria decumbens, wherein the combination provides at least about 80% control of the weed at or within 35 days after its application.

In an embodiment, the present invention provides the use of L-glufosinate, salts, esters, or combinations thereof applied at a rate of 150 g a.i./ha, in association with 25 g a.i./ha of quizalofop-p-tefuryl to control at least one weed that is Brachiaria decumbens, wherein the combination provides at least about 82% control of the weed at or within 14 days after its application, at least about 80% control of the weed at or within 21 days after its application, at least about 80% control of the weed at or within 28 days after its application, and at least about 80% control of the weed at or within 35 days after its application.

In an embodiment, the present invention provides the use of L-glufosinate, salts, esters, or combinations thereof applied at a rate of 150 g a.i./ha, in association with 50 g a.i./ha of haloxyfop to control at least one weed that is Eleusine indica.

In an embodiment, the present invention provides the use of L-glufosinate, salts, esters, or combinations thereof applied at a rate of 150 g a.i./ha, in association with 50 g a.i./ha of haloxyfop to control Eleusine indica, wherein the combination provides at least about 65% control of the weed at or within 7 days after its application.

In an embodiment, the present invention provides the use of L-glufosinate, salts, esters, or combinations thereof applied at a rate of 150 g a.i./ha, in association with 25 g a.i./ha of quizalofop-ethyl to control Eleusine indica, wherein the combination provides about 100% control of the weed at or within 21 days after its application.

In an embodiment, the present invention provides the use of L-glufosinate, salts, esters, or combinations thereof applied at a rate of 150 g a.i./ha, in association with 25 g a.i./ha of quizalofop-p-tefuryl to control Eleusine indica, wherein the combination provides at least about 40% control of the weed at or within 21 days after its application.

In an embodiment, the present invention provides the use of L-glufosinate, salts, esters, or combinations thereof applied at a rate of 150 g a.i./ha, in association with 25 g a.i./ha of quizalofop-p-tefuryl to control Eleusine indica, wherein the combination provides at least about 35% control of the weed at or within 28 days after its application.

In an embodiment, the present invention provides the use of L-glufosinate, salts, esters, or combinations thereof applied at a rate of 150 g a.i./ha, in association with 25 g a.i./ha of quizalofop-p-tefuryl to control Eleusine indica, wherein the combination provides at least about 30% control of the weed at or within 35 days after its application.

In an embodiment, the present invention provides the use of L-glufosinate, salts, esters, or combinations thereof applied at a rate of 150 g a.i./ha, in association with 25 g a.i./ha of quizalofop-p-tefuryl to control Eleusine indica, wherein the combination provides at least about 40% control of the weed at or within 21 days after its application, at least about 35% control of the weed at or within 28 days after its application, and at least about 30% control of the weed at or within 35 days after its application.

In an embodiment, the present invention provides the use of L-glufosinate, salts, esters, or combinations thereof applied at a rate of 150 g a.i./ha, in association with 50 g a.i./ha of haloxyfop to control at least one weed that is Spermacoce latifolia.

In an embodiment, the present invention provides the use of L-glufosinate, salts, esters, or combinations thereof applied at a rate of 150 g a.i./ha, in association with 50 g a.i./ha of haloxyfop to control Spermacoce latifolia, wherein the combination provides at least about 68% control of the weed at or within 7 days after its application.

In an embodiment, the present invention provides the use of L-glufosinate, salts, esters, or combinations thereof applied at a rate of 150 g a.i./ha, in association with 50 g a.i./ha of haloxyfop to control Spermacoce latifolia, wherein the combination provides at least about 93% control of the weed at or within 14 days after its application

In an embodiment, the present invention provides the use of L-glufosinate, salts, esters, or combinations thereof applied at a rate of 150 g a.i./ha, in association with 50 g a.i./ha of haloxyfop to control Spermacoce latifolia, wherein the combination provides at least about 99% control of the weed at or within 21 days after its application.

In an embodiment, the present invention provides the use of L-glufosinate, salts, esters, or combinations thereof applied at a rate of 150 g a.i./ha, in association with 50 g a.i./ha of haloxyfop to control Spermacoce latifolia, wherein the combination provides at least about 100% control of the weed at or within 28 days after its application.

In an embodiment, the present invention provides the use of L-glufosinate, salts, esters, or combinations thereof applied at a rate of 150 g a.i./ha, in association with 50 g a.i./ha of haloxyfop to control Spermacoce latifolia, wherein the combination provides at least about 100% control of the weed at or within 35 days after its application.

In an embodiment, the present invention provides the use of L-glufosinate, salts, esters, or combinations thereof applied at a rate of 150 g a.i./ha, in association with 50 g a.i./ha of haloxyfop to control Spermacoce latifolia, wherein the combination provides at least about 68% control of the weed at or within 7 days after its application, wherein the combination provides at least about 93% control of the weed at or within 14 days after its application, wherein the combination provides at least about 99% control of the weed at or within 21 days after its application, wherein the combination provides at least about 100% control of the weed at or within 28 days after its application, and wherein the combination provides at least about 100% control of the weed at or within 35 days after its application.

In an embodiment, the present invention provides the use of L-glufosinate, salts, esters, or combinations thereof applied at a rate of 150 g a.i./ha, in association with 50 g a.i./ha of haloxyfop to control at least one weed that is Glycine max.

In an embodiment, the present invention provides the use of L-glufosinate, salts, esters, or combinations thereof applied at a rate of 150 g a.i./ha, in association with 50 g a.i./ha of haloxyfop to control Glycine max, wherein the combination provides at least about 30% control of the weed at or within 3 days after its application.

In an embodiment, the present invention provides the use of L-glufosinate, salts, esters, or combinations thereof applied at a rate of 150 g a.i./ha, in association with 50 g a.i./ha of haloxyfop to control Glycine max, wherein the combination provides at least about 85% control of the weed at or within 7 days after its application.

In an embodiment, the present invention provides the use of L-glufosinate, salts, esters, or combinations thereof applied at a rate of 150 g a.i./ha, in association with 50 g a.i./ha of haloxyfop to control Glycine max, wherein the combination provides at least about 90% control of the weed at or within 14 days after its application.

In an embodiment, the present invention provides the use of L-glufosinate, salts, esters, or combinations thereof applied at a rate of 150 g a.i./ha, in association with 50 g a.i./ha of haloxyfop to control Glycine max, wherein the combination provides at least about 90% control of the weed at or within 21 days after its application.

In an embodiment, the present invention provides the use of L-glufosinate, salts, esters, or combinations thereof applied at a rate of 150 g a.i./ha, in association with 50 g a.i./ha of haloxyfop to control Glycine max, wherein the combination provides at least about 90% control of the weed at or within 28 days after its application.

In an embodiment, the present invention provides the use of L-glufosinate, salts, esters, or combinations thereof applied at a rate of 150 g a.i./ha, in association with 50 g a.i./ha of haloxyfop to control Glycine max, wherein the combination provides at least about 88% control of the weed at or within 35 days after its application.

In an embodiment, the present invention provides the use of L-glufosinate, salts, esters, or combinations thereof applied at a rate of 150 g a.i./ha, in association with 50 g a.i./ha of haloxyfop to control Glycine max, wherein the combination provides at least about 30% control of the weed at or within 3 days after its application, at least about 85% control of the weed at or within 7 days after its application, at least about 90% control of the weed at or within 14 days after its application, at least about 90% control of the weed at or within 21 days after its application, at least about 90% control of the weed at or within 28 days after its application, and at least about 88% control of the weed at or within 35 days after its application.

In an embodiment, the present invention provides the use of L-glufosinate, salts, esters, or combinations thereof applied at a rate of 150 g a.i./ha, in association with 25 g a.i./ha of quizalofop-ethyl to control Glycine max, wherein the combination provides at least about 55% control of the weed at or within 3 days after its application.

In an embodiment, the present invention provides the use of L-glufosinate, salts, esters, or combinations thereof applied at a rate of 150 g a.i./ha, in association with 25 g a.i./ha of quizalofop-ethyl to control Glycine max, wherein the combination provides at least about 45% control of the weed at or within 28 days after its application.

In an embodiment, the present invention provides the use of L-glufosinate, salts, esters, or combinations thereof applied at a rate of 150 g a.i./ha, in association with 25 g a.i./ha of quizalofop-ethyl to control Glycine max, wherein the combination provides at least about 45% control of the weed at or within 35 days after its application.

In an embodiment, the present invention provides the use of L-glufosinate, salts, esters, or combinations thereof applied at a rate of 150 g a.i./ha, in association with 25 g a.i./ha of quizalofop-ethyl to control Glycine max, wherein the combination provides at least about 55% control of the weed at or within 3 days after its application, at least about 45% control of the weed at or within 28 days after its application, and at least about 45% control of the weed at or within 35 days after its application.

In an embodiment, the present invention provides the use of L-glufosinate, salts, esters, or combinations thereof applied at a rate of 150 g a.i./ha, in association with 25 g a.i./ha of quizalofop-p-tefuryl to control Glycine max, wherein the combination provides at least about 60% control of the weed at or within 3 days after its application.

In an embodiment, the present invention provides the use of L-glufosinate, salts, esters, or combinations thereof applied at a rate of 150 g a.i./ha, in association with 25 g a.i./ha of quizalofop-p-tefuryl to control Glycine max, wherein the combination provides at least about 100% control of the weed at or within 28 days after its application.

In an embodiment, the present invention provides the use of L-glufosinate, salts, esters, or combinations thereof applied at a rate of 150 g a.i./ha, in association with 25 g a.i./ha of quizalofop-p-tefuryl to control Glycine max, wherein the combination provides at least about 100% control of the weed at or within 35 days after its application.

In an embodiment, the present invention provides the use of L-glufosinate, salts, esters, or combinations thereof applied at a rate of 150 g a.i./ha, in association with 25 g a.i./ha of quizalofop-p-tefuryl to control Glycine max, wherein the combination provides at least about 60% control of the weed at or within 3 days after its application, at least about 100% control of the weed at or within 28 days after its application, and at least about 100% control of the weed at or within 35 days after its application.

The combinations and the compositions of the present invention may be applied in any known ways or conventional methods known to a person skilled in art. Non-limiting examples of such methods are foliar spray, basal barking, stem injection, drill and fill method, axe cut method, cut stump, cut and swab, stem scraper, wick application and so forth. The compositions of the present invention are used in the customary manner, for example by watering, spraying, atomizing, dusting or scattering. The combinations and the compositions of the present invention can be applied to a locus by the use of conventional ground sprayers, granule applicators, watering (drenching), drip irrigation, spraying, atomizing, broadcasting, dusting, foaming, spreading-on, aerial methods of spraying, aerial methods of application, methods utilizing application using modern technologies such as, but not limited to, drones, robots and by other conventional means known to those skilled in the art.

Typically, for the product of the present invention, the composition is applied at a rate that is ranging from 1-1000 kg/ha. Yet, the weight ratios of individual components can be varied within relatively wide ranges. Typically, there are 1:1000 to 1000:1 parts by weight of the active compounds.

The combinations of the present invention may be developed as a pre-mix composition or a kit of parts such that individual actives may be mixed before applying.

Thus, an embodiment of the present invention provides a kit-of-parts comprising a component of L-glufosinate, salts, esters, or combinations thereof and a second component of an herbicide of the phenoxypropionic herbicide class. In an embodiment, one of the two components or both may be admixed with at least one or more agrochemically suitable excipients. Optionally, the kit-of-parts may comprise a second additional herbicide as a third component or in a pre-mix with either of the two herbicidal components of the composition of the present invention. The kit-of-parts may further comprise a component comprising an agrochemically suitable excipient. The kit of parts may contain either of the L-glufosinate herbicide or a salt thereof and the herbicide of the phenoxypropionic herbicide class previously admixed, individually or together, with an adjuvant or an agrochemically suitable excipient such that the two components may be tank mixed before applying. The kit-of-parts may be further accompanied by a set of instructions in form of a manual, guide, booklet, pamphlet, and so forth.

These combinations or compositions as described above may be applied to the weed or to locus of the weeds or to the plant/crop, in synergistically effective amount. It can be seen from the use examples herein below that the found herbicidal action of the active compound combinations according to the invention exceeds the calculated value, that is to say that the new active compound combinations have a synergistic effect in controlling weeds.

This effectiveness of all treatments can be evaluated according to Colby's equation. In the Colby's equation given below, E is the expected efficacy of combination of L-glufosinate, salts, esters, or combinations thereof, and an herbicide of the phenoxypropionic herbicide class,
X is the observed efficacy of L-glufosinate, salts, esters, or combinations thereof and
Y is the observed efficacy of the herbicide of the phenoxypropionic herbicide class.

Observed efficacy values i.e. X and Y are % weed control for L-glufosinate, salts, esters, or combinations thereof and an herbicide of the phenoxypropionic herbicide class. If observed efficacy of combination of L-glufosinate, salts, esters, or combinations thereof and the herbicide of the phenoxypropionic herbicide class is greater than its expected efficacy, then combination is determined to be synergistic. If observed efficacy is equal to or less than expected efficacy, then combination is determined to be non-synergistic.

$$Colby ’ s equation E = X + Y - XY / 100$$

The results of synergistic effects of the present combinations/compositions is represented in examples. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth.

Specifically, the invention includes embodiments in which particular subject matter is excluded, in full or in part, such as substances or materials, method steps and conditions, protocols, procedures, assays or analysis. Thus, even though the invention is generally not expressed herein in terms of what the invention does not include aspects that are not expressly included in the invention are nevertheless disclosed herein. A number of embodiments of the invention have been described. Nevertheless, it will be understood that various modifications may be made without departing from the spirit and scope of the invention.

These and other advantages of the invention may become more apparent from the examples set forth. These examples are provided merely as illustrations of the invention and are not intended to be construed as a limitation thereof.

Specifically, the invention includes embodiments in which a particular subject matter is excluded, in full or in part, such as substances or materials, method steps and conditions, protocols, procedures, assays or analysis. Thus, even though the invention is generally not expressed herein in terms of what the invention does not include aspects that are not expressly included in the invention are nevertheless disclosed herein.

### EXAMPLES

The following examples demonstrate the present invention.

### Composition:

Following active ingredient compounds were used in the present invention to prepare combinations/compositions of L-glufosinate ammonium with phenoxypropionic herbicides.

| | Amount | Dose |
|---|---|---|
| Active ingredient | (g a.i./L) | (g a.i./ha) |
| L-glufosinate ammonium | 280 | 150 |
| Haloxyfop | 125 | 50 |
| Quizalofop-ethyl | 50 | 25 |
| Quizalofop-p-tefuryl | 120 | 25 |

### Evaluation of Post-Emergence Herbicidal Activity of Combination Under Field Conditions

Methodology: Greenhouse trials were carried out to evaluate the efficacy of the combination of L-glufosinate ammonium and phenoxypropionic herbicides—haloxyfop, quizalofop-ethyl, quizalofop-P-tefuryl—on weeds Eleusine indica, Brachiaria decumbens, Spermacoce latifolia and Glycine max.

The soil used was sandy clay loam-Sand: 68.0%; Silt: 8.0%; Clay: 24.0%.

All treatments were in 4 replications per treatment with a spray volume of 150 L/h.

### Evaluation

The expected efficacy of a combination of L-glufosinate and the other herbicides was calculated using the well-established Colby method. Any difference between the observed and “expected” efficacy could be attributed to synergy between the two compounds. (Colby, S. R., Weeds, 1967 (15), p. 20-22).

### Example 1

Experiment was conducted to assess the efficacy herbicidal combination comprising L-glufosinate ammonium (glufosinate-p-ammonium) and haloxyfop to control the weed, Brachiaria decumbens.

Table 1 demonstrates synergy on weeds using the combination of L-glufosinate ammonium and haloxyfop. The percentage efficacy was calculated after 7, 14 days of application (DAA). The target weed was Brachiaria decumbens, and the concentration of the herbicide and the results are recorded in the table 1 below:

TABLE 1

| Active ingredient, dose | 7 DAA | | 14 DAA | |
|---|---|---|---|---|
| (g a.i./ha) | Control % | Colby* | Control % | Colby* |
| L-glufosinate ammonium, 150 | 50 | | 79.3 | |
| Haloxyfop, 50 | 26.7 | | 75.3 | |
| L-glufosinate ammonium, | 67.7 | 63.4 | 98.7 | 94.9 |
| 150 + haloxyfop, 50 | | | | |

*Expected efficacy according to Colby's Formula

### Example 2

Experiment was conducted to assess the efficacy herbicidal combination comprising L-glufosinate ammonium (glufosinate-p-ammonium) and quizalofop-ethyl to control the weed, Brachiaria decumbens.

Table 2 demonstrates synergy on weeds using the combination of L-glufosinate ammonium and quizalofop-ethyl. The percentage efficacy was calculated after 28 and 35 days of application (DAA). The target weed was Brachiaria decumbens, and the concentration of the herbicide and the results are recorded in the table 2 below:

TABLE 2

| Active ingredient, dose | 28 DAA | | 35 DAA | |
|---|---|---|---|---|
| (g a.i./ha) | Control % | Colby* | Control % | Colby* |
| L-glufosinate ammonium, 150 | 60 | | 55 | |
| quizalofop-ethyl, 25 | 35 | | 30 | |
| L-glufosinate ammonium, | 80 | 74 | 80 | 68.5 |
| 150 + quizalofop-ethyl, 25 | | | | |

*Expected efficacy according to Colby's Formula

### Example 3

Experiment was conducted to assess the efficacy herbicidal combination comprising L-glufosinate ammonium (glufosinate-p-ammonium) and quizalofop-P-tefuryl to control the weed, Brachiaria decumbens.

Table 3 demonstrates synergy on weeds using the combination of L-glufosinate ammonium and quizalofop-p-tefuryl. The percentage efficacy was calculated after 14, 21, 28, 35 days of application (DAA). The target weed was Brachiaria decumbens, and the concentration of the herbicide and the results are recorded in the table 3 below:

TABLE 3

| Active | 14 DAA | | 21 DAA | | 28 DAA | | 35 DAA | |
|---|---|---|---|---|---|---|---|---|
| ingredient, | Control | | Control | | Control | | Control | |
| dose a.i., g/ha | % | Colby * | % | Colby * | % | Colby * | % | Colby * |
| L-glufosinate | 75 | | 70 | | 60 | | 55 | |
| ammonium, 150 | | | | | | | | |
| quizalofop- | 20 | | 10 | | 5 | | 5 | |
| p-tefuryl, 25 | | | | | | | | |
| L-glufosinate | 82 | 80 | 80 | 73 | 80 | 62 | 80 | 57 |
| ammonium, 150 + | | | | | | | | |
| quizalofop- | | | | | | | | |
| p-tefuryl, 25 | | | | | | | | |

* Expected efficacy according to Colby's Formula

### Example 4

Experiment was conducted to assess the efficacy herbicidal combination comprising L-glufosinate ammonium (glufosinate-p-ammonium) and haloxyfop to control the weed, Eleusine indica.

Table 4 demonstrates synergy on weeds using the combination of L-glufosinate ammonium and haloxyfop. The percentage efficacy was calculated after 7 days of application (DAA). The target weed was Eleusine indica, and the concentration of the herbicide and the results are recorded in the table 4 below:

TABLE 4

7 DAA

| Active ingredient, g ai/ha | % control | Colby* |
|---|---|---|
| L-glufosinate ammonium, 150 | 50.7 | — |
| Haloxyfop, 50 | 25 | — |
| L-glufosinate ammonium, 150 + | 65 | 63 |
| haloxyfop, 50 | | |

*Expected efficacy according to Colby's Formula

### Example 5

Experiment was conducted to assess the efficacy herbicidal combination comprising L-glufosinate ammonium (glufosinate-p-ammonium) and quizalofop-ethyl to control the weed, Eleusine indica.

Table 5 demonstrates synergy on weeds using the combination of L-glufosinate ammonium and quizalofop-ethyl. The percentage efficacy was calculated after 21 days of application (DAA). The target weed was Eleusine indica, and the concentration of the herbicide and the results are recorded in the table 5 below:

TABLE 5

21 DAA

| Active ingredient, g ai/ha | % control | Colby* |
|---|---|---|
| L-glufosinate ammonium, 150 | 35 | — |
| quizalofop-ethyl, 25 | 95 | — |
| L-glufosinate ammonium, 150 + | 100 | 96 |
| quizalofop-ethyl, 25 | | |

*Expected efficacy according to Colby's Formula

### Example 6

Experiment was conducted to assess the efficacy herbicidal combination comprising L-glufosinate ammonium (glufosinate-p-ammonium) and quizalofop-P-tefuryl to control the weed, Eleusine indica.

Table 6 demonstrates synergy on weeds using the combination of L-glufosinate ammonium and quizalofop-p-tefuryl. The percentage efficacy was calculated after 21, 28, 35 days of application (DAA). The target weed was Eleusine indica, and the concentration of the herbicide and the results are recorded in the table 6 below:

TABLE 6

| Active | 21 DAA | | 28 DAA | | 35 DAA | |
|---|---|---|---|---|---|---|
| ingredient, | Control | | Control | | Control | |
| dose a.i., g/ha | % | Colby* | % | Colby* | % | Colby* |
| L-glufosinate | 25 | | 20 | | 18 | |
| ammonium, | | | | | | |
| 150 | | | | | | |
| quizalofop-p- | 10 | | 5 | | 5 | |
| tefuryl, 25 | | | | | | |
| L-glufosinate | 40 | 32.5 | 35 | 24 | 30 | 22.1 |
| ammonium, | | | | | | |
| 150 + | | | | | | |
| quizalofop-p- | | | | | | |
| tefuryl, 25 | | | | | | |

*Expected efficacy according to Colby's Formula

### Example 7

Experiment was conducted to assess the efficacy herbicidal combination comprising L-glufosinate ammonium (glufosinate-p-ammonium) and haloxyfop to control the weed, Spermacoce latifolia.

Table 7 demonstrates synergy on weeds using the combination of L-glufosinate ammonium and haloxyfop. The percentage efficacy was calculated after 7, 14, 21, 28, 35 days of application (DAA). The target weed was Spermacoce latifolia, and the concentration of the herbicide and the results are recorded in the table 7 below:

TABLE 7

| Active | 7 DAA | | 14 DAA | | 21 DAA | | 28 DAA | | 35 DAA | |
|---|---|---|---|---|---|---|---|---|---|---|
| ingredient, | Control | | Control | | Control | | Control | | Control | |
| dose a.i., g/ha | % | Colby* | % | Colby* | % | Colby* | % | Colby* | % | Colby* |
| L-glufosinate | 31.7 | | 81.7 | | 83.3 | | 83.3 | | 83.3 | |
| ammonium, 150 | | | | | | | | | | |
| Haloxyfop, 50 | 8 | | 8.7 | | 10 | | 31 | | 9.3 | |
| L-glufosinate | 68.3 | 37.2 | 93.3 | 83.3 | 99.3 | 85 | 100 | 88.5 | 100 | 84.9 |
| ammonium, 150 + | | | | | | | | | | |
| haloxyfop, 50 | | | | | | | | | | |

*Expected efficacy according to Colby's Formula

### Example 8

Experiment was conducted to assess the efficacy herbicidal combination comprising L-glufosinate ammonium (glufosinate-p-ammonium) and haloxyfop to control the weed, Glycine max.

Table 8 demonstrates synergy on weeds using the combination of L-glufosinate ammonium and haloxyfop. The percentage efficacy was calculated after 3, 7, 14, 21, 28, 35 days of application (DAA). The target weed was Glycine max, and the concentration of the herbicide and the results are recorded in the table 8 below:

TABLE 8

| Active | 3 DAA | | 7 DAA | | 14 DAA | | 21 DAA | | 28 DAA | | 35 DAA | |
|---|---|---|---|---|---|---|---|---|---|---|---|---|
| ingredient, | % | | % | | % | | % | | % | | % | |
| gai/ha | control | Colby* | control | Colby* | control | Colby* | control | Colby* | control | Colby* | control | Colby* |
| L-glufosinate | 15 | — | 53.3 | — | 71 | — | 66.7 | — | 56.7 | — | 41.7 | — |
| ammonium, 150 | | | | | | | | | | | | |
| Haloxyfop, 50 | 5 | — | 13.3 | — | 15 | — | 12.3 | — | 12.3 | — | 12.3 | — |
| L-glufosinate | 31 | 19.3 | 87.3 | 59.5 | 91 | 75.4 | 92.3 | 70.8 | 90 | 62 | 88.3 | 48.9 |
| ammonium, 150 + | | | | | | | | | | | | |
| haloxyfop, 50 | | | | | | | | | | | | |

*Expected efficacy according to Colby's Formula

### Example 9

Experiments were conducted to assess the efficacy of herbicidal combination comprising L-glufosinate ammonium (glufosinate-p-ammonium) and quizalofop-ethyl to control the weedy Glycine max.

Table 9 demonstrates synergy on weeds using the combination of L-glufosinate ammonium and quizalofop-ethyl. The percentage efficacy was calculated after 3, 28 and 35 days of applications (DAA). The target weed was Glycine max, and the concentration of the herbicide and the results are recorded in the table 9 below:

TABLE 9

| Active | 3 DAA | | 28 DAA | | 35 DAA | |
|---|---|---|---|---|---|---|
| ingredient, | Control | | Control | | Control | |
| dose a.i., g/ha | % | Colby* | % | Colby* | % | Colby* |
| L-glufosinate | 50 | | 40 | | 40 | |
| ammonium, | | | | | | |
| 150 | | | | | | |
| quizalofop- | 0 | | 0 | | 0 | |
| ethyl, 25 | | | | | | |
| L-glufosinate | 55 | 50 | 45 | 40 | 45 | 40 |
| ammonium, | | | | | | |
| 150 + | | | | | | |
| quizalofop- | | | | | | |
| ethyl, 25 | | | | | | |

*Expected efficacy according to Colby's Formula

### Example 10

Experiments were conducted to assess the efficacy of herbicidal combination comprising L-glufosinate ammonium (glufosinate-p-ammonium) and quizalofop-p-tefuryl to control the weedy Glycine max.

Table 10 demonstrates synergy on weeds using the combination of L-glufosinate ammonium and quizalofop-p-tefuryl. The percentage efficacy was calculated after 3, 28 and 35 days of applications (DAA). The target weed was Glycine max, and the concentration of the herbicide and the results are recorded in the table 10 below.

TABLE 10

| Active | 3 DAA | | 28 DAA | | 35 DAA | |
|---|---|---|---|---|---|---|
| ingredient, | Control | | Control | | Control | |
| dose a.i., g/h | % | Colby* | % | Colby* | % | Colby* |
| L-glufosinate | 50 | | 60 | | 55 | |
| ammonium, | | | | | | |
| 150 | | | | | | |
| quizalofop-p- | 0 | | 0 | | 0 | |
| tefuryl, 25 | | | | | | |
| L-glufosinate | 60 | 50 | 100 | 60 | 100 | 55 |
| ammonium, | | | | | | |
| 150 + | | | | | | |
| quizalofop-p- | | | | | | |
| tefuryl, 25 | | | | | | |

*Expected efficacy according to Colby's Formula

1. A herbicidal combination comprising:
(a) L-glufosinate, salts, esters, or combinations thereof; and
(b) at least one additional herbicide selected from the group consisting of a phenoxypropionic herbicides.

2. The combination as claimed in claim 1, wherein the salt comprises an inorganic salt of L-glufosinate.

3. The combination as claimed in claim 2, wherein the inorganic salt of L-glufosinate is selected from the group consisting of L-glufosinate ammonium, L-glufosinate sodium, L-glufosinate potassium, and combinations thereof.

4. The combination as claimed in claim 1, wherein the phenoxypropionic herbicide is selected from the group consisting of chlorazifop, chlorazifop-propargyl, clodinafop, clodinafop propargyl, clofop, clofop-isobutyl, cyhalofop, cyhalofop-butyl, diclofop, diclofop-methyl, difenopenten, fenoxaprop, fenoxaprop-P, fenthiaprop, fluazifop, fluazifop-butyl, fluazifop-P, fluazifop-P-butyl, haloxyfop, haloxyfop-sodium, haloxyfop-methyl, haloxyfop-etotyl, haloxyfop-P, haloxyfop-P-methyl, isoxapyrifop, kuicaoxi, metamifop, propaquizafop, quizalofop, quizalofop-ethyl, quizalofop-P, quizalofop-P-ethyl, quizalofop-P-tefuryl, trifop, trifopsime, er and combinations thereof.

5. The combination as claimed in claim 4, wherein the phenoxypropionic herbicide is selected from the group consisting of haloxyfop, haloxyfop-sodium, haloxyfop-methyl, haloxyfop-etotyl, haloxyfop-P, haloxyfop-P-methyl, quizalofop, quizalofop-ethyl, quizalofop-P, quizalofop-P-ethyl, quizalofop-p-tefuryl, and combinations thereof.

6. The combination as claimed in claim 1, wherein a weight ratio of L-glufosinate, salts, esters, or combinations thereof to the at least one additional herbicide is in a range from about 25:1 to about 1:25.

7. The combination as claimed in claim 1, wherein the herbicidal combination further comprises a second additional herbicide.

8. The combination as claimed in claim 1, wherein a weight ratio of L-glufosinate, salts, esters, or combinations thereof, the at least one additional herbicide and a second additional herbicide is in a range from about 25:1:1 to about 1:25:25.

9. The combination as claimed in claim 1, wherein the combination comprises:
(a) the L-glufosinate, salts, esters, or combinations thereof in a range from about 100 g a.i./L to about 400 g a.i./L; and
(b) the at least one additional herbicide selected from the group consisting of the phenoxypropionic herbicide in a range from about 100 g a.i./L to about 400 g a.i./L.

10. The combination as claimed in claim 1, wherein the combination comprises:
(a) the L-glufosinate, salts, esters, or combinations thereof applied at an application rate from about 100 g a.i./ha to about 500 g a.i./ha; and
(b) the at least one additional herbicide selected from the group consisting of the phenoxypropionic herbicide applied at an application rate from about 10 g a.i./ha to about 500 g a.i./ha.

11. A method for controlling weeds by applying a herbicidal combination comprising:
(a) L-glufosinate, salts, esters, or combinations thereof; and
(b) at least one additional herbicide selected from the group consisting of a phenoxypropionic herbicide.

12. The method as claimed in claim 11, wherein the weeds are selected from the group comprising Eleusine indica, Brachiaria decumbens, Spermacoce latifolia, Glycine max, or combinations thereof.

13. The method as claimed in claim 11, wherein the combination is applied jointly, or separately, or sequentially, or simultaneously to a plant or locus thereof to control from about 30% to about 100% of the weeds.

14. (canceled)

15. A herbicidal composition comprising:
(a) L-glufosinate, salts, esters, or combinations thereof;
(b) at least one additional herbicide selected from the group consisting of a phenoxypropionic herbicide; and
(c) at least one agrochemically acceptable excipient.
